(19) United States
(12) Patent Application Publication
(10) Pub. No.: US 2019/0140468 A1
(43) Pub. Date: May 9, 2019

(54) COIL MODULE AND WIRELESS MOBILE TERMINAL USING THE SAME

(71) Applicant: Samsung Electro-Mechanics Co., Ltd., Suwon-si (KR)

(72) Inventors: Jae Hyuk JANG, Suwon-si (KR); Hyun Jung LEE, Suwon-si (KR); Young Seung ROH, Suwon-si (KR); Yeong Hwan SONG, Suwon-si (KR); Jae Sun WON, Suwon-si (KR)

(73) Assignee: Samsung Electro-Mechanics Co., Ltd., Suwon-si (KR)

(21) Appl. No.: 16/016,987

(22) Filed: Jun. 25, 2018

(30) Foreign Application Priority Data
Nov. 7, 2017 (KR) 10-2017-0147442

(51) Int. Cl. H02J 7/02; H02J 50/10; H04B 5/00

(52) U.S. Cl. CPC H02J 7/025; H04B 5/0037; H04B 5/0081; H02J 50/10

(57) ABSTRACT

A coil module includes a coil part including a coil substrate and a coil pattern formed on the coil substrate; and a magnetic body part comprising, in a first part of the coil module, a first thickness which overlaps the coil substrate and comprising, in a second part of the coil module, a second thickness, thicker than the first thickness, which does not overlap the coil substrate.

### CROSS-REFERENCE TO RELATED APPLICATION

This application claims the benefit under 35 USC 119(a) to Korean Patent Application No. 10-2017-0147442 filed on Nov. 7, 2017 in the Korean Intellectual Property Office, the disclosure of which is incorporated herein by reference for all purposes.

### BACKGROUND

### 1. Field

The present disclosure relates to a coil module and a wireless mobile terminal using the same.

### 2. Description of Related Art

As mobile terminals such as smartphones have become increasingly popular and functions of these mobile terminals have improved, various local area wireless communication-based functions have been added to mobile terminals.

One of the above-mentioned functions is to provide a non-contact approval function based on local area wireless communication using a coil applied to the mobile terminal.

As examples of such a non-contact approval function, a method using near field communication (NFC) has typically been proposed and a magnetic secure transmission (MST) method capable of performing an AS approval without adding a separate reader to a point of sale (POS) terminal has recently been proposed.

In a coil module for such local area wireless communication, demands on an increase of a recognition rate of such local area communication and miniaturization or slimming of the coil module according to miniaturization of the mobile terminal are increased.

### SUMMARY

This Summary is provided to introduce a selection of concepts in a simplified form that are further discussed below in the Detailed Description. This Summary is not intended to identify key features of the claimed subject matter, nor is this Summary intended to be used as an aid in determining the scope of the claimed subject matter.

In one general aspect, a coil module includes a coil part comprising a coil substrate and a coil pattern formed on the coil substrate; and a magnetic body part including, in a first part of the coil module, a first thickness that overlaps the coil substrate and comprising, in a second part of the coil module, a second thickness, that does not overlap the coil substrate, wherein the second thickness is greater than the first thickness.

The coil part may include a first coil pattern formed on a first surface of the coil substrate; and a second coil pattern formed on a second surface of the coil substrate, and the first coil pattern and the second coil pattern may be electrically connected to each other by a via electrode that penetrates through the coil substrate.

The first coil pattern, the via electrode, and the second coil pattern may form a spiral coil.

The magnetic body part may include a first magnetic body formed on the first surface of the coil substrate in a position that corresponds to a position of the second coil pattern; and a second magnetic body may be formed on the second surface of the coil substrate in a position that corresponds to a position of the first coil pattern.

The first magnetic body may be configured to extend in a first direction, and the second magnetic body may be configured to extend in a second direction opposite to the first direction.

A length of the second magnetic body may be greater than a length of the first magnetic body.

The magnetic body part may include a first magnetic body plate that has the first thickness; and a second magnetic body plate stacked on the first magnetic body plate, the second magnetic plate may have a third thickness, and the second thickness may be a sum of the first thickness and the third thickness.

The first magnetic body plate may have magnetic characteristics different from the second magnetic body plate.

A saturation magnetic flux density value of the first magnetic body plate may be greater than a saturation magnetic flux density value of the second magnetic body plate.

Permeability of the second magnetic body plate may be greater than permeability of the first magnetic body plate.

In another general aspect, a coil module includes a coil part comprising a coil substrate, a first coil pattern formed on a first surface of the coil substrate, and a second coil pattern formed on a second surface of the coil substrate; a first magnetic body formed on the first surface of the coil substrate in a position that corresponds to a position of the second coil pattern; and a second magnetic body formed on the second surface of the coil substrate in a position that corresponds to a position of the first coil pattern.

The first coil pattern and the second coil pattern may be electrically connected to each other by a via electrode that penetrates through the coil substrate, and the first coil pattern, the via electrode, and the second coil pattern may form a spiral coil.

The first magnetic body may include a first magnetic body plate that has a first thickness; and a second magnetic body plate stacked on the first magnetic body plate, the second magnetic plate having a second thickness.

The first magnetic body plate may be formed to be stacked on the coil substrate, and the second magnetic body plate may be formed in a position that is separate from the coil substrate, and the second magnetic body plate may be formed in a position that is separate from the coil substrate.

The second magnetic body may include a third magnetic body plate that has the first thickness; and a fourth magnetic body plate stacked on the third magnetic body plate, the fourth magnetic body plate may have the second thickness, and the first magnetic body plate may have magnetic characteristics that correspond to the third magnetic body plate, and the second magnetic body plate may have magnetic characteristics that correspond to the fourth magnetic body plate.

A saturation magnetic flux density value of the first magnetic body plate may be greater than a saturation magnetic flux density of the second magnetic body plate.

In another general aspect, a coil module includes a coil part comprising a coil substrate, a first coil pattern formed on a first surface of the coil substrate, and a second coil pattern formed on a second surface of the coil substrate; a first magnetic body that has a first length, and is formed on the first surface of the coil substrate in a position that corresponds to a position of the second coil pattern; and a second magnetic body that has a second length that is greater than the first length of the first magnetic body, and is formed on the second surface of the coil substrate in a position that corresponds to a position of the first coil pattern.

The first coil pattern and the second coil pattern may be electrically connected to each other by a via electrode.

The first coil pattern, the via electrode, and the second coil pattern may form a spiral coil.

The first magnetic body may have magnetic characteristics different from the second magnetic body.

### BRIEF DESCRIPTION OF THE DRAWINGS

FIG. 1 is a perspective view illustrating an example of a coil module according to the present disclosure;

FIG. 2 is an example of an exploded perspective view of a coil module;

FIG. 3 is an example of a plan view of a coil module;

FIG. 4 is an example of a cross-sectional view of a coil module;

FIG. 5 is a perspective view illustrating an example of a coil module according to the present disclosure;

FIG. 6 is an example of an exploded perspective view of a coil module;

FIG. 7 is an example of a plan view of a coil module;

FIG. 8 is an example of a cross-sectional view of a coil module;

FIG. 9 is a rear view illustrating an example of a mobile terminal including a coil module according to the present disclosure; and

FIG. 10 is an example of a cross-sectional view of a mobile terminal.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example or embodiment, e.g., as to what an example or embodiment may include or implement, means that at least one example or embodiment exists where such a feature is included or implemented while all examples and embodiments are not limited thereto.

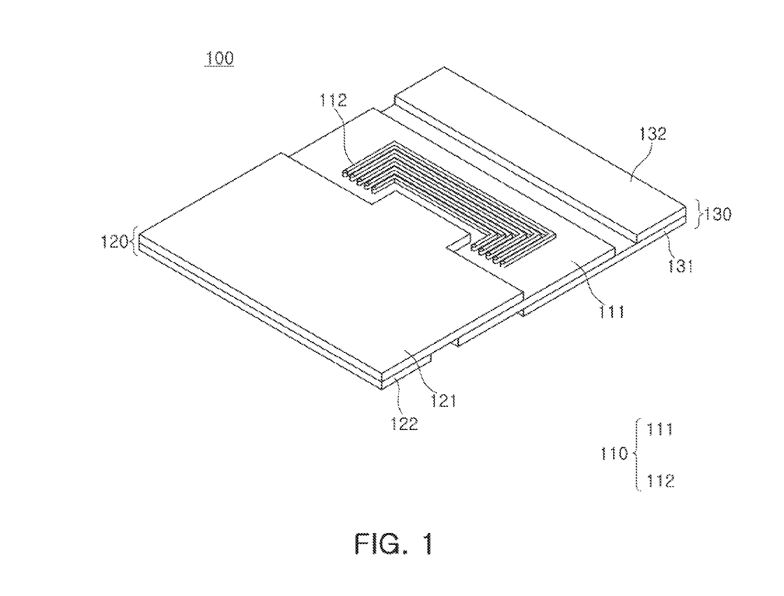

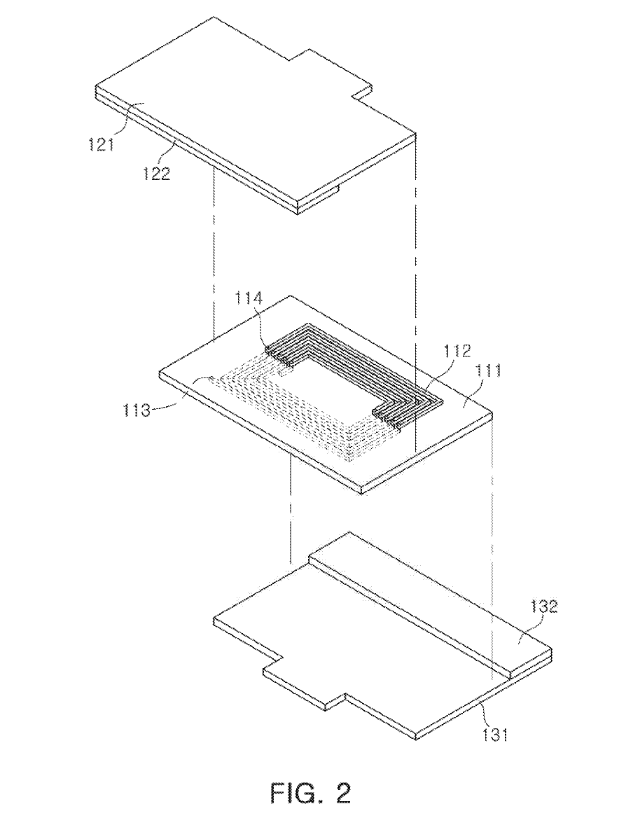

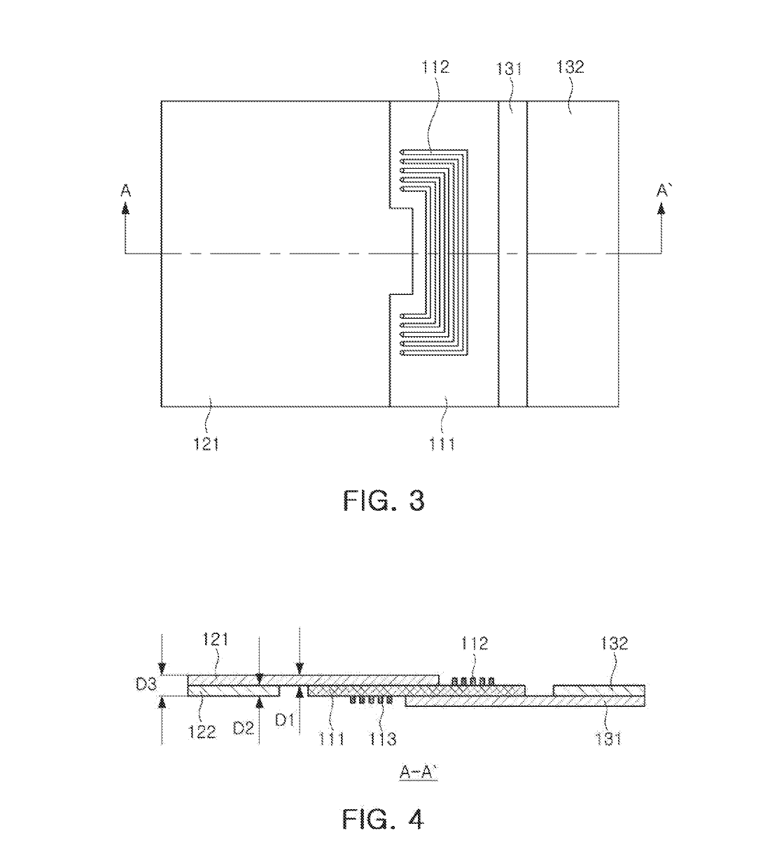

FIG. 1 illustrates an example of a perspective view of a coil module according to the present disclosure, FIG. 2 is an example of an exploded perspective view of the coil module illustrated in FIG. 1, FIG. 3 is a plan view of the coil module illustrated in FIG. 1, and FIG. 4 is a cross-sectional view of the coil module taken along a line A-A′ of FIG. 3.

FIGS. 1 through 5, a coil module 100 may include coil parts 111, 112, and 113, and magnetic body parts 120 and 130, for example, noting that examples are not limited thereto.

The coil parts 111, 112, and 113 may include a coil substrate 111, and coil patterns 112 and 113 formed on the coil substrate 111.

The coil parts 111, 112, and 113 include a first coil pattern 112 formed on a first surface of the coil substrate 111 and a second coil pattern 113 formed on a second surface of the coil substrate 111. However, this is only an example, and the first coil pattern 112 and the second coil pattern 113 may be formed on the same surface of the coil substrate 111.

In the example illustrated in FIG. 1, the coil module 100 includes two coil parts 112 and 113, but is not limited thereto. The coil module 100 may include two or more coils parts 112 on a first side of the coil substrate 111, and two or more coil parts 113 on a second side of the coil substrate 111.

The first coil pattern 112 and the second coil pattern 113 are electrically connected to each other by a via electrode 114 that penetrates through the coil substrate 111. Although FIG. 2 illustrates that the via electrode 114 is included in the first coil pattern 112, this is merely an example, and the via electrode 114 may be included in the second coil pattern 113.

Since the via electrode 114 is formed by filling a conductive material into a via hole penetrating through the coil substrate 111, the via electrode 114 may be formed in the coil substrate 111.

One end of the via electrode 114 may be connected to one end of the first coil pattern 112 and the other end of the via electrode 114 may be connected to one end of the second coil pattern 113, such that an end of the first coil pattern 112 and an end of the second coil pattern 113 may be connected to each other.

The first coil pattern 112, the second coil pattern 113, and the via electrode 114 may form a spiral coil.

As an example, the first coil pattern 112 may correspond to a shape of at least a portion of the spiral coil and the second coil pattern 113 may correspond to a shape of the remaining portion of the spiral coil. For example, as illustrated in FIG. 2, the first coil pattern 112 and the second coil pattern 113 are formed on different surfaces of the coil substrate 111 in a symmetrical manner.

For example, the magnetic body parts include a first magnetic body 120 and a second magnetic body 130.

The first magnetic body 120 is disposed in a position corresponding to the second coil pattern 113 on a first surface of the coil substrate 111, that is, the surface on which the first coil pattern 112 is formed. In other words, the first magnetic body 120 and the second coil pattern 113 are formed on opposite sides of the coil substrate 111 and are disposed directly above each other. Similarly, the second magnetic body 130 is disposed in a position corresponding to the first coil pattern 112 on a second surface of the coil substrate 111, that is, the surface on which the second coil pattern 113 is formed. In other words, the second magnetic body 130 and the first coil pattern 112 are formed on opposite sides of the coil substrate 111 and are disposed directly above each other.

At least a portion of the first magnetic body 120 and the second magnetic body 130 are stacked on the coil substrate 111, but may not be directly stacked on the coil patterns 112 and 113, or in direct physical contact with coil pattern 112 and coil pattern 113. That is, as illustrated in the cross-sectional view of FIG. 4, the first magnetic body 120 and the second magnetic body 130 are stacked so that portions of the coil patterns and magnetic bodies are provided on the respective surfaces with respect to the coil substrate 111. Therefore, according to the present example, since the magnetic bodies are not directly stacked on the coil patterns, the coil module may have a thin form factor.

As an example, the first magnetic body 120 extends in a first direction and the second magnetic body 130 extends in a second direction opposite to the first direction. For example, referring to the plan view illustrated in FIG. 3, the first magnetic body 120 extends in a left direction and the second magnetic body 130 extends in a right direction.

A thickness of a portion of the coil module in which the magnetic body parts 120 and 130 overlap the coil substrate and a thickness of at least a portion of the coil module in which the magnetic body parts 120 and 130 do not overlap the coil substrate may be different from each other.

In the example illustrated in FIG. 1, the coil module 100 includes two magnetic body parts 120 and 130, but is not limited thereto. The coil module 100 may include two or more magnetic body parts 120 and two or more magnetic body parts 130.

As illustrated in FIG. 4, the first magnetic body 120 and the second magnetic body 130 have a first thickness D1 in a portion of the coil module in which the first magnetic body 120 and the second magnetic body 130 overlap the coil substrate 111, and have a second thickness D3 thicker than the first thickness in at least a portion of the coil module in which the first magnetic body 120 and the second magnetic body 130 do not overlap the coil substrate 111.

According to an example, the first magnetic body 120 and the second magnetic body 130 include a plurality of magnetic body plates which are in a stacked formation.

As an example, the first magnetic body 120 includes a first magnetic body plate 121 having a first thickness D1 and a second magnetic body plate 122 stacked on or below the first magnetic body plate 121 and having a second thickness D2.

Therefore, a portion of the coil module in which the first magnetic body plate 121 and the second magnetic body plate 122 are stacked in the first magnetic body 120 correspond to a third thickness D3 in which the first thickness D1 and the second thickness D2 are summed.

That is, the first magnetic body plate 121 is stacked on the coil substrate 111, and the second magnetic body plate 122 is stacked on or below the first magnetic plate 121 at least at a portion of the coil module in which the first magnetic body plate 121 does not overlap the coil substrate 111. As a result, the thickness of the portion of the first magnetic body 120 stacked on the coil substrate 111 may be thinner the thickness of the portion of the first magnetic body 120 which is not stacked on the coil substrate 111. Accordingly, an entire thickness of the coil module is formed to have a thin form factor.

According to an example, the first magnetic body 120 and the second magnetic body 130 each include magnetic body plates which have different magnetic characteristics, and the differing magnetic body plates are formed in a stacked manner.

As an example, saturation magnetic flux density values of first magnetic body plates 121 and 131 are greater than saturation magnetic flux density values of second magnetic body plates 122 and 132. For example, the saturation magnetic flux density values of the first magnetic body plates 121 and 131 may correspond to 0.7 to 2.0 tesla (T). Accordingly, magnetic flux density increases in portions of the coil module in which the magnetic body plates are stacked on the coil substrate, that is, portions of the coil module in which a cross section area of each of the magnetic body plates is small may be accommodated.

As another example, permeability of the second magnetic body plates 122 and 132 is greater than permeability of the first magnetic body plates 121 and 131. For example, the permeability of the second magnetic body plates 122 and 132 may be 5,000 to 100,000. Accordingly, the permeability may be sufficiently secured even in the portions of the coil module where the magnetic body plates do not overlap the coil substrate 111 (for example, the coil substrate may be a flexible printed circuit board (FPCB)), thereby improving recognition performance in wireless communication.

Although the above discussion describes that the first magnetic body plate 121 included in the first magnetic body 120 and the second magnetic body plate 131 included in the second magnetic body 130 have structures and magnetic characteristic corresponding to each other, and the second magnetic body plate 122 included in the first magnetic body 120 and the fourth magnetic body plate 132 included in the second magnetic body 130 have structures and magnetic characteristic corresponding to each other, this is merely an example.

Therefore, the first magnetic body 120 and the second magnetic body 130 have different structures or magnetic characteristics.

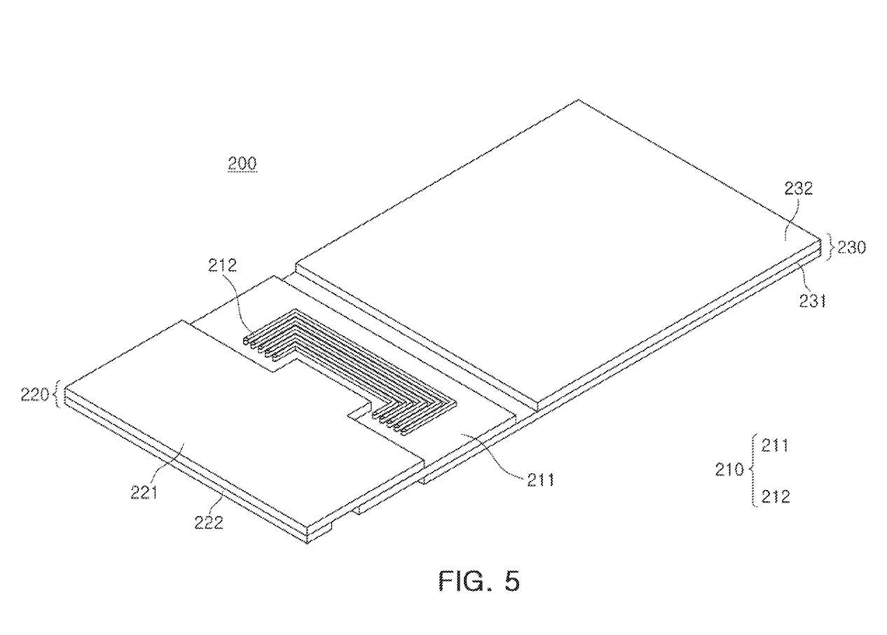

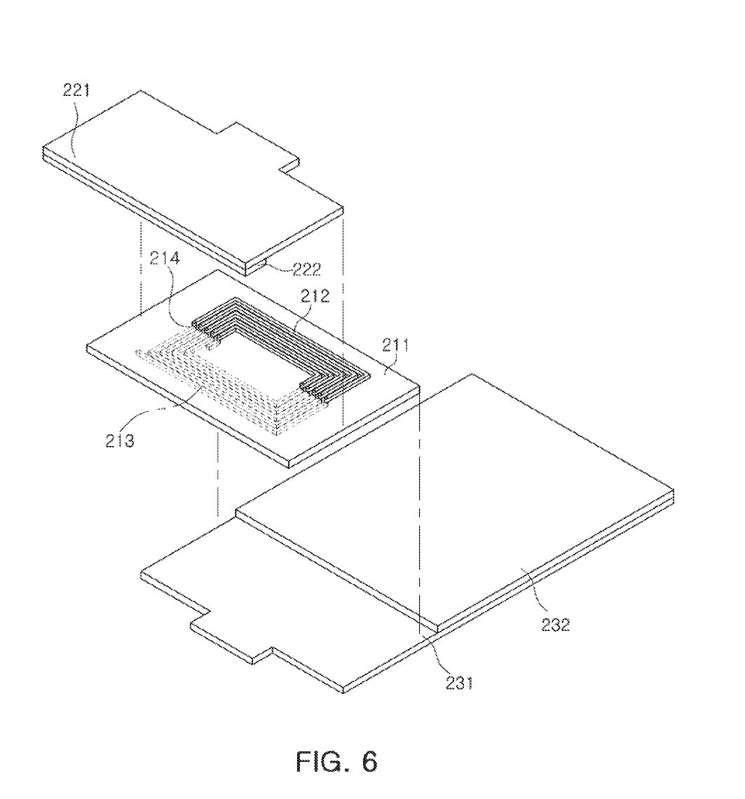

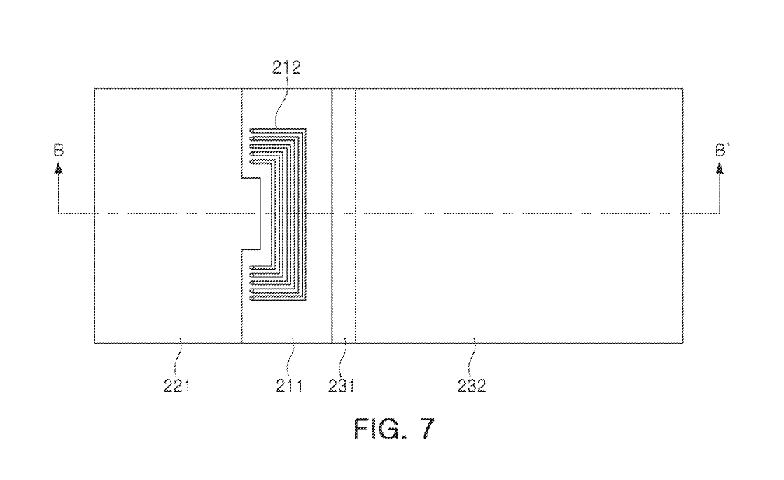

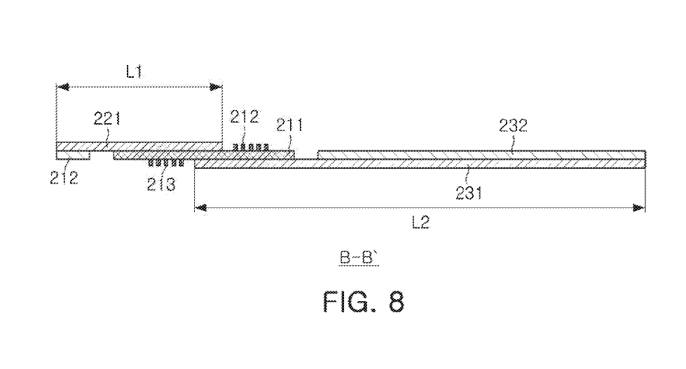

FIG. 5 is a perspective view illustrating a coil module according to another example of the present disclosure and FIG. 6 is an example of an exploded perspective view of the coil module illustrated in FIG. 5. FIG. 7 is an example of a plan view of the coil module illustrated in FIG. 5 and FIG. 8 is an example of a cross-sectional view of the coil module taken along a line B-B′ of FIG. 7.

A coil module 200 according to an example of the present disclosure includes coil parts 211, 212, and 213, a first magnetic body 220, and a second magnetic body 230, for example.

The coil parts 211, 212, and 213 include a coil substrate 211, and coil patterns 212 and 213 formed on the coil substrate 211. The coil parts 211, 212, and 213 include a first coil pattern 212 formed on a first surface of the coil substrate 211 and a second coil pattern 213 formed on a second surface of the coil substrate 211. The first coil pattern 212 and the second coil pattern 213 are electrically connected to each other by a via electrode 214 that penetrates through the coil substrate 211.

The coil parts may be easily understood from the discussion above with reference to FIGS. 1 through 4.

The first magnetic body 220 is provided in a position on a first surface of the coil substrate 211 corresponding to the second coil pattern 213 on which the first coil pattern 212 is formed. In other words, the first magnetic body 220 and the second coil pattern 213 are formed on opposite sides of the coil substrate 211.

The second magnetic body 230 is provided in a position corresponding to the first coil pattern 212 on a second surface of the coil substrate 211 on which the second coil pattern 213 is formed. In other words, the second magnetic body 230 and the first coil pattern 212 are formed on opposite sides of the coil substrate 211.

The first magnetic body 220 and the second magnetic body 230 may be easily understood from the discussion above with reference to FIGS. 1 through 4, e.g., such as is necessary to the included example where the first magnetic body 120 and the second magnetic body 130 have different sizes.

According to this example, a length of the second magnetic body 230 may be greater than a length of the first magnetic body 220.

That is, considering an overall structure of the coil module 200, a position of the coil parts 211, 212, and 213 is tilted to one side of the coil module 200. Thus, in the mobile terminal to which the coil module 200 is applied, the length of the magnetic body is set in a different manner according to the position of the coil module 200, such that the coil module 200 may be efficiently applied even in various application environments of the mobile terminal.

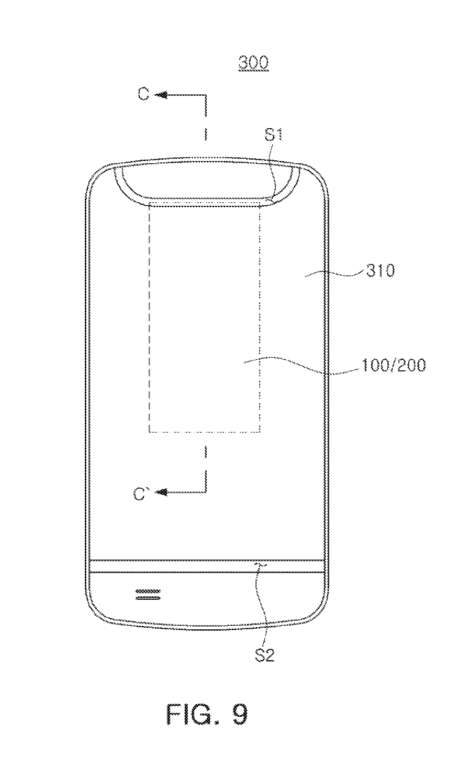

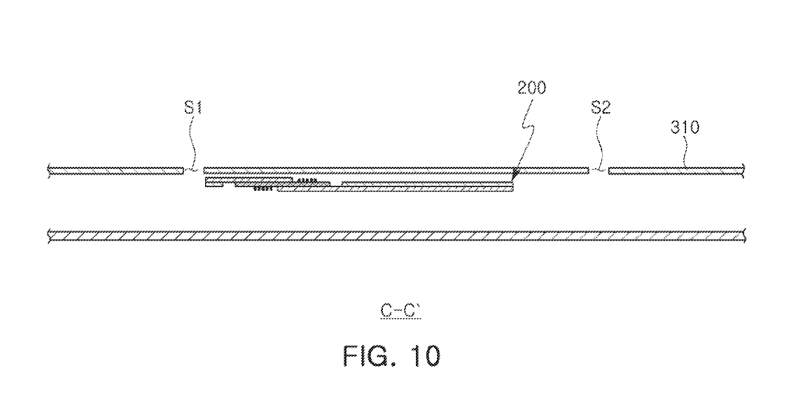

FIG. 9 is a rear view illustrating a mobile terminal including a coil module according to an example of the present disclosure and FIG. 10 is an example of a cross-sectional view of the mobile terminal taken along a line C-C′ of FIG. 9.

Referring to FIG. 9, a mobile terminal 300 includes the coil module 100/200 disposed in a terminal cover 310.

The cover 310 may be an outer housing of a terminal body 300 and may be a battery cover separated from the terminal 300 when a battery is replaced. However, the cover 310 is not limited thereto, and may also include an integral cover which is difficult to separate from the terminal 300.

The cover 310 may be formed of a metal material (e.g., aluminum, or any other type of metal). In a case in which the entirety of the cover 310 is formed of the metal material, radio waves radiating from the coil module 100 for wireless communication are shielded by the cover 310 and wireless communication may not be properly performed, the cover 310 according to the present example includes nonmetal regions S1 and S2 formed of a nonmetal material.

The nonmetal regions S1 and S2 may be empty spaces, or may be filled with a non-conductive material such as resin or polymer.

The present example discloses an example in which a U-shaped slit S1 and a horizontal slit S2, which are the nonmetal regions, are formed in an upper end and a lower end of the cover 310, respectively. However, the nonmetal regions are not limited thereto, but may be formed in a shape or a number different from that illustrated in FIG. 9.

As illustrated in FIG. 10, the coil module 200 is disposed inside the cover 310 of the mobile terminal 300. That is, the coil module 200 is disposed on an inner surface of the cover 310 and is disposed at a position adjacent to the first slit S1. However, this is only an example, and the coil module may be in the body of the mobile terminal 300, separate from the inner surface of the cover 310.

The coil module 200 is disposed so that a magnetic body, for example, the first magnetic body 220 in FIG. 5, which has a shorter length than a magnetic body 230, is positioned in a direction of the first slit S1 adjacent thereto, and a magnetic body, for example, the second magnetic body 230 in FIG. 5, which has a longer length than magnetic body 220, is positioned in a direction of the second slit S2.

That is, in a case in which a magnetic field for wireless communication is formed by the coil module 100/200, a portion of the magnetic field forms a loop through the first slit S1 and the second slit S2 of the mobile terminal 300.

That is, since the first slit S1 is adjacent to the coil module 100/200, the magnetic field may be easily exposed to the external environment through the first slit S1, but since the second slit S2 is relatively far from the coil module 100, the magnetic field may be minimally exposed to the external environment through the second slit S2. Therefore, according to an example in the present disclosure, the first magnetic body 220 which has a relatively short length is disposed in the direction of the first slit S1 adjacent to the coil module 100/200 and the second magnetic body 230 is disposed in the direction of the second slit S2 which is relatively far from the coil module 100/200, such that the magnetic field may easily pass through the second slit S2 according to an influence of the second magnetic body 230.

As set forth above, according to the examples in the present disclosure, the recognition rate in the wireless communication terminals may be improved based on the magnetic body.

Additionally, according to an example in the present disclosure, the coil module may have a thin form factor.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil module comprising:
a coil part comprising a coil substrate and a coil pattern formed on the coil substrate; and
a magnetic body part comprising, in a first part of the coil module, a first thickness that overlaps the coil substrate and comprising, in a second part of the coil module, a second thickness, that does not overlap the coil substrate, wherein the second thickness is greater than the first thickness.

2. The coil module of claim 1, wherein the coil part comprises:
a first coil pattern formed on a first surface of the coil substrate; and
a second coil pattern formed on a second surface of the coil substrate, and
the first coil pattern and the second coil pattern are electrically connected to each other by a via electrode that penetrates through the coil substrate.

3. The coil module of claim 2, wherein the first coil pattern, the via electrode, and the second coil pattern form a spiral coil.

4. The coil module of claim 2, wherein the magnetic body part comprises:
a first magnetic body formed on the first surface of the coil substrate in a position that corresponds to a position of the second coil pattern; and
a second magnetic body formed on the second surface of the coil substrate in a position that corresponds to a position of the first coil pattern.

5. The coil module of claim 4, wherein the first magnetic body is configured to extend in a first direction, and
the second magnetic body is configured to extend in a second direction opposite to the first direction.

6. The coil module of claim 4, wherein a length of the second magnetic body is greater than a length of the first magnetic body.

7. The coil module of claim 1, wherein the magnetic body part comprises:
a first magnetic body plate that has the first thickness; and
a second magnetic body plate stacked on the first magnetic body plate, the second magnetic plate having a third thickness, and
the second thickness is a sum of the first thickness and the third thickness.

8. The coil module of claim 7, wherein the first magnetic body plate has magnetic characteristics different from the second magnetic body plate.

9. The coil module of claim 8, wherein a saturation magnetic flux density value of the first magnetic body plate is greater than a saturation magnetic flux density value of the second magnetic body plate.

10. The coil module of claim 8, wherein permeability of the second magnetic body plate is greater than permeability of the first magnetic body plate.

11. A coil module comprising:
a coil part comprising a coil substrate, a first coil pattern formed on a first surface of the coil substrate, and a second coil pattern formed on a second surface of the coil substrate;
a first magnetic body formed on the first surface of the coil substrate in a position that corresponds to a position of the second coil pattern; and
a second magnetic body formed on the second surface of the coil substrate in a position that corresponds to a position of the first coil pattern.

12. The coil module of claim 11, wherein the first coil pattern and the second coil pattern are electrically connected to each other by a via electrode that penetrates through the coil substrate, and
the first coil pattern, the via electrode, and the second coil pattern form a spiral coil.

13. The coil module of claim 11, wherein the first magnetic body comprises:
a first magnetic body plate that has a first thickness; and
a second magnetic body plate stacked on the first magnetic body plate, the second magnetic plate having a second thickness.

14. The coil module of claim 13, wherein the first magnetic body plate is formed to be stacked on the coil substrate, and
the second magnetic body plate is formed in a position that is separate from the coil substrate.

15. The coil module of claim 13, wherein the second magnetic body comprises:
a third magnetic body plate that has the first thickness; and
a fourth magnetic body plate stacked on the third magnetic body plate, the fourth magnetic body plate having the second thickness, and
the first magnetic body plate has magnetic characteristics that correspond to the third magnetic body plate, and
the second magnetic body plate has magnetic characteristics that correspond to the fourth magnetic body plate.

16. The coil module of claim 13, wherein a saturation magnetic flux density value of the first magnetic body plate is greater than a saturation magnetic flux density of the second magnetic body plate.

17. A coil module comprising:
a coil part comprising a coil substrate, a first coil pattern formed on a first surface of the coil substrate, and a second coil pattern formed on a second surface of the coil substrate;
a first magnetic body that has a first length, and is formed on the first surface of the coil substrate in a position that corresponds to a position of the second coil pattern; and
a second magnetic body that has a second length that is greater than the first length of the first magnetic body, and is formed on the second surface of the coil substrate in a position that corresponds to a position of the first coil pattern.

18. The coil module of claim 17, wherein the first coil pattern and the second coil pattern are electrically connected to each other by a via electrode.

19. The coil module of claim 18, wherein the first coil pattern, the via electrode, and the second coil pattern form a spiral coil.

20. The coil module of claim 17, wherein the first magnetic body has magnetic characteristics different from the second magnetic body.
